(19) United States
(12) Patent Application Publication
(10) Pub. No.: US 2012/0088215 A1
(43) Pub. Date: Apr. 12, 2012

(54) INTEGRATED MODEL FOR OTOSCOPIC PROCEDURES

(75) Inventors: Fausto Bellezzo, Fort Collins, CO (US); Dean A. Hendrickson, Fort Collins, CO (US)

(73) Assignee: COLORADO STATE UNIVERSITY RESEARCH FOUNDATION, Fort Collins, CO (US)

(21) Appl. No.: 13/267,598

(22) Filed: Oct. 6, 2011

Related U.S. Application Data
(60) Provisional application No. 61/391,768, filed on Oct. 11, 2010.

(51) Int. Cl. G09B 23/30

(52) U.S. Cl. 434/270

(57) ABSTRACT

An otoscopic model is disclosed herein. In one embodiment, the otoscopic model includes an artificial ear, an artificial head and at least one tympanic membrane portion. The artificial ear includes a base portion and an ear portion extending from the base and having ear-like features including an auditory canal. The artificial head includes an opening adapted to receive the base portion. The at least one tympanic membrane portion includes an artificial tympanic membrane. The tympanic membrane portion is configured to be coupled with the artificial ear such that the artificial tympanic membrane is located relative to the auditory canal in a generally anatomically correct manner.

### CROSS REFERENCE TO RELATED APPLICATIONS

The present application incorporates in its entirety and claims the benefit under 35U.S.C. §119(e) of U.S. Provisional Application 61/391,768, which was filed Oct. 11, 2010 and entitled “Integrated Model for Otoscopic Procedures.”

### FIELD OF THE INVENTION

The present invention relates to simulated anatomical models and methods of making such models. More specifically, the present invention relates to simulated ear structures and related methods of manufacture.

### BACKGROUND OF THE INVENTION

Medical diagnostic and surgical techniques are learned by physically practicing such techniques. For example, a student may practice identifying and treating an ear disease on a living patient (e.g., a dog, pig, etc.) or a cadaver. Each of these has it disadvantages.

For example, while practicing diagnosing and treating ear diseases on living animals offers the advantage of actual conditions, there are high associated costs due to having to obtain, take care of, and dispose of the animals. Also, societal attitudes are increasingly less favorable towards the use of animals for such purposes.

Practicing diagnosing and treating ear diseases on cadavers is less realistic than with actual living animals due to a lack of flowing body fluids and living body temperatures, the differences between indications of an ear disease in living tissue versus dead tissue, and the physical characteristics of dead tissue. Also, there are high costs associated with obtaining, maintaining, and disposing of cadavers.

There is a need in the art for simulated otoscopic models useable for practicing diagnosis and treatment techniques for ear disease, wherein the simulated otoscopic models overcome the above-discussed disadvantages.

### BRIEF SUMMARY OF THE INVENTION

An otoscopic model is disclosed herein. In one embodiment, the otoscopic model includes an artificial ear, an artificial head and at least one tympanic membrane portion. The artificial ear includes a base portion and an ear portion extending from the base and having ear-like features including an auditory canal. The artificial head includes an opening adapted to receive the base portion. The at least one tympanic membrane portion includes an artificial tympanic membrane. The tympanic membrane portion is configured to be coupled with the artificial ear such that the artificial tympanic membrane is located relative to the auditory canal in a generally anatomically correct manner.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the spirit and scope of the present invention. Accordingly, the drawings and detailed description are to be regarded as illustrative in nature and not restrictive.

### BRIEF DESCRIPTION OF THE DRAWINGS

FIGS. 1-3 are different perspective views of an integrated otoscopic model.

FIG. 4 is an exploded perspective view of one embodiment of the otoscopic model.

FIG. 5 is a cross sectional elevation through a region of the otoscopic model of FIG. 1.

FIG. 6 is an exploded perspective view of another embodiment of the otoscopic model.

FIGS. 7 and 8 are the same views of FIG. 5, except of other embodiments.

FIG. 9A-9F are six otoscopic photographs of different artificial tympanic membranes of different tympanic membrane portions that are intended to reflect six different ear medical conditions.

### DETAILED DESCRIPTION

Integrated otoscopic models 10 are disclosed herein. The otoscopic models 10 bring an increased level of realism in medical diagnostic and treatment education. Specifically, the otoscopic models 10 have realistic appearances and are realistic in response to manipulation and surgical interventions and diagnostic techniques. Such otoscopic models 10 can greatly enhance how diagnostic and surgical skills are taught with respect to ear diseases, bringing the medical trainee another step closer to mastering diagnostic and surgical techniques before ever touching a live patient. The otoscopic models 10 are advantageous because they offer a truly realistic diagnostic and treatment experience akin to working on a living animal.

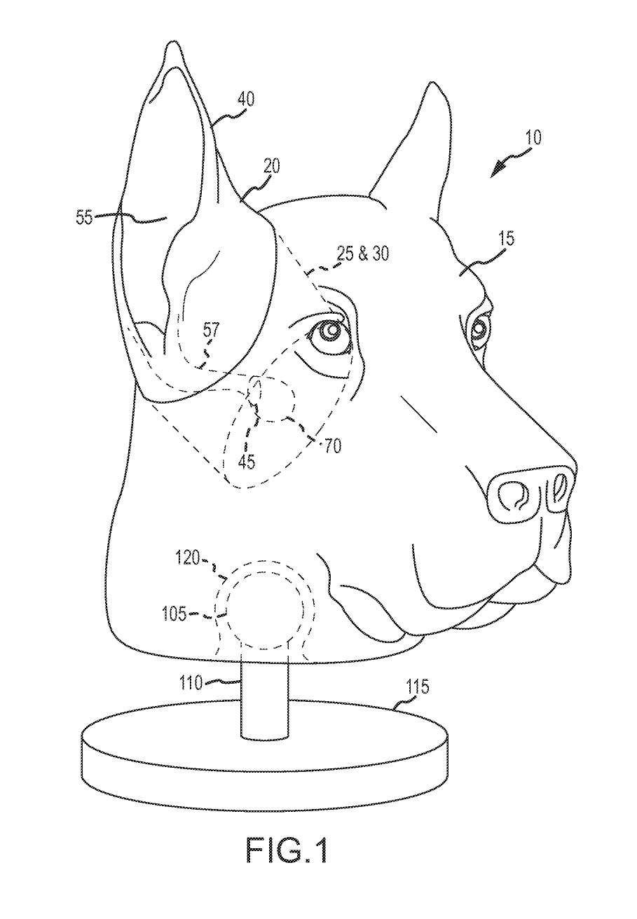

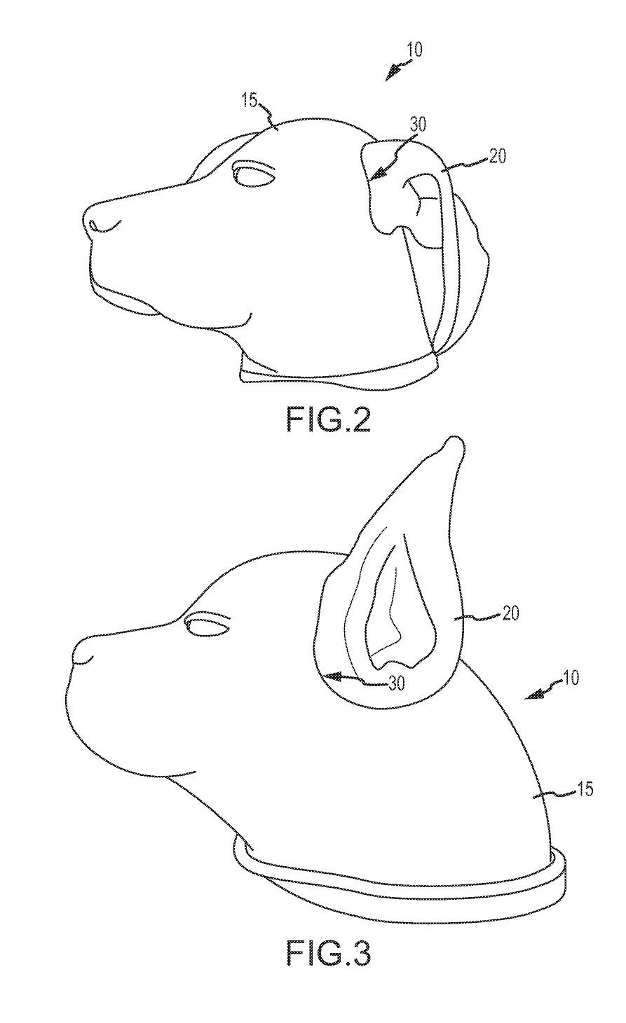

In one embodiment, the integrated otoscopic models 10 include an artificial head 15 and an artificial ear 20 that is coupled to the head in a removable fashion. For example, as shown in FIGS. 1-3, which are various perspective views of an otoscopic model 10, in one embodiment, a base portion 25 of the artificial ear 20 is recessed in the head 15. While the otoscopic model 10 is shown in FIG. 1 and the rest of this disclosure as being in the form of a canine head, it should be understood that the disclosure is readily applicable to the ear structure of any other living thing, including all types of animals and humans. Accordingly, the disclosure should not be construed to be limited to otoscopic models of a canine nature but should be interpreted as encompassing any and all types of life, including all animals and humans.

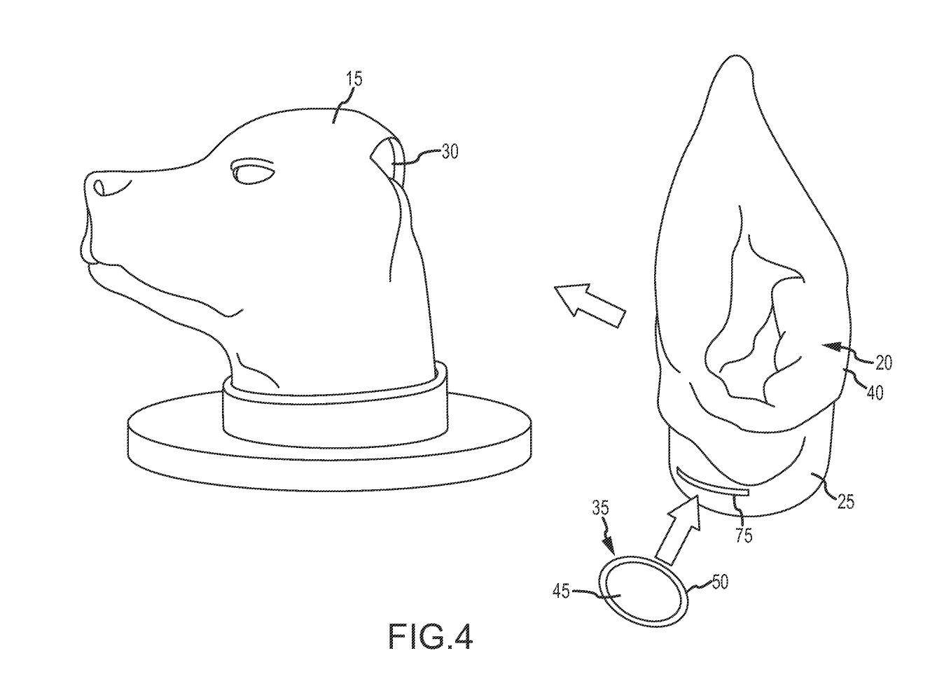

As can be understood from FIG. 4, which is an exploded perspective view of one embodiment of the otoscopic model 10, the otoscopic model 10 includes an artificial head 15, an artificial ear 20 and an artificial tympanic membrane portion 35. The artificial head 15 includes an opening 30 defined therein in the location where an ear would be anatomically correctly located. The artificial ear 20 includes a base portion 25 and an ear portion 40. The artificial tympanic membrane portion 35 includes an artificial tympanic membrane 45 and a ring 50 that supports the artificial tympanic membrane and across which the artificial tympanic membrane extends. The ring may be made of metal, polymer or any material capable of providing sufficient support for the membrane that will allow the artificial tympanic membrane portion 35 to be inserted into the artificial ear 20 as described below.

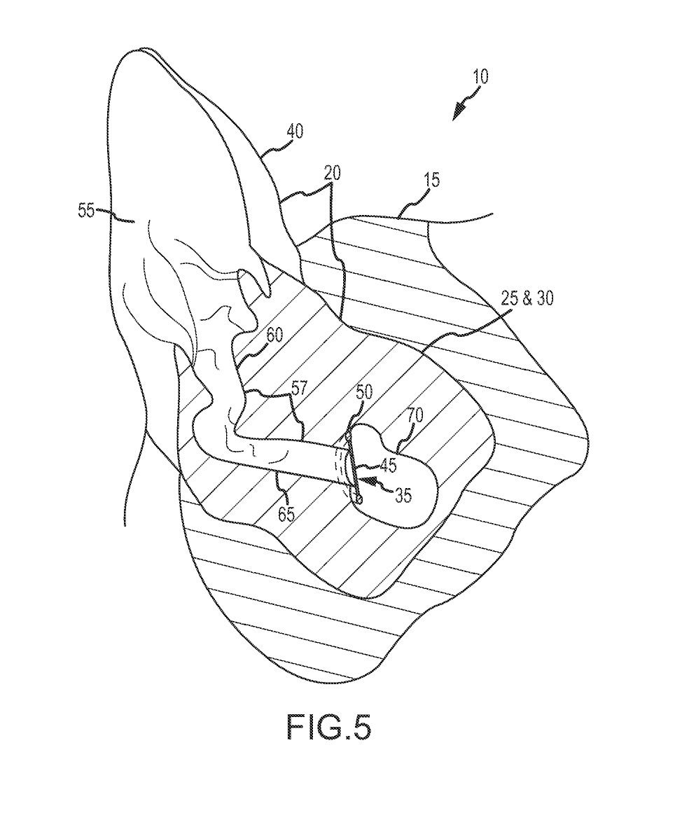

As indicated in FIG. 5, which is a cross sectional elevation through a region of the otoscopic model 10 of FIG. 1, the ear portion 40 of the artificial ear 20 has ear-like features, such as, for example, the pina 55, auditory canal 57 and tympanic bulla 70. The auditory canal 57 may include its features, including, for example, the vertical canal 60 and horizontal canal 65.

As indicated in FIG. 4, the artificial ear further includes an access 75 extending into the artificial ear 20 to a location between the auditory canal 57 and the tympanic bulla 70 that is anatomically occupied by a tympanic membrane. The access 75 may be located in the base portion 25 or in the ear portion 40 or between the two so long as the access 75 is configured to receive and deliver the tympanic membrane portion 35 between the auditory canal 57 and the tympanic bulla 70 when the artificial tympanic membrane is located relative to the auditory canal in a generally anatomically correct manner, as indicated by FIG. 5. In one embodiment, as depicted in FIG. 4, the access 75 is a slot.

As can be understood from FIG. 4, the artificial ear 20 is removable from the head 15. Specifically, the artificial ear may be mounted in the head, as indicated in FIGS. 1-3 and 5, by inserting the base portion 25 of the ear 20 into the opening 30 defined in the head 15. In one embodiment, an interference fit between the base portion and opening maintains the base portion in the opening in a snug and secure manner.

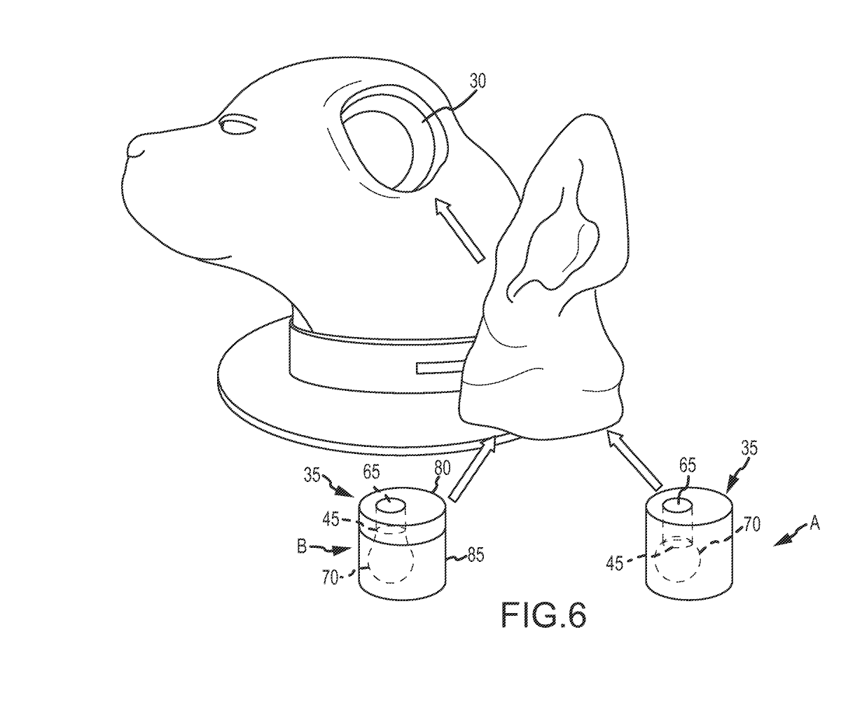

As indicated in FIG. 6, which is an exploded perspective view of another embodiment of the otoscopic model 10, the tympanic membrane portion 35 is a cylindrical or other shaped body. The body 35 may be a one-piece monolithic body (indicated by arrow A) or a multi-piece arrangement (indicated by arrow B). The opening 30 in the artificial head 15 is configured to receive both the base portion 25 of the artificial ear 20 and the tympanic membrane portion 35.

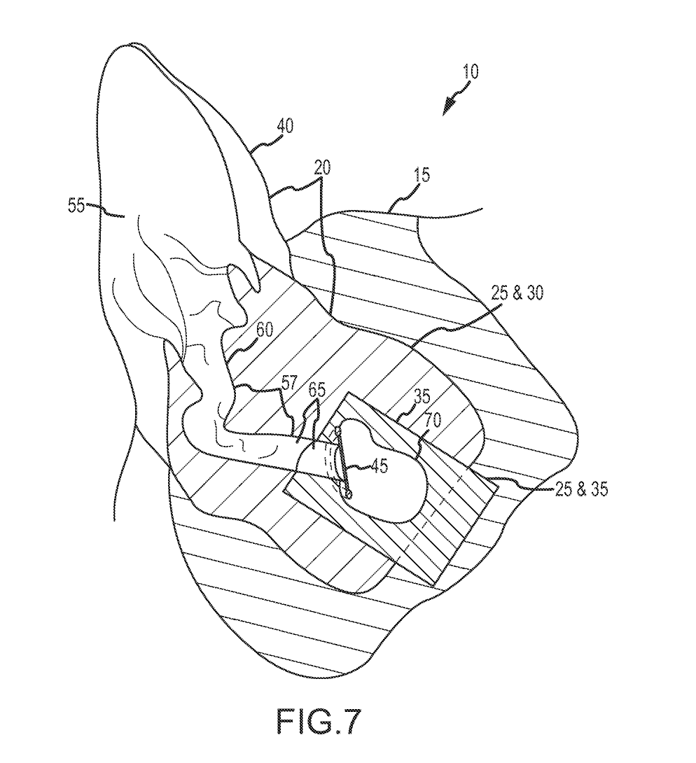

In one embodiment, as illustrated in FIG. 7, which is the same view as FIG. 5, and discussed with respect to the tympanic membrane portion 35 identified in FIG. 6 by arrow A, the tympanic membrane portion 35 includes an artificial tympanic membrane 45 and a tympanic bulla 70 immediately adjacent the artificial tympanic membrane 45. The artificial tympanic membrane 45 and tympanic bulla 70 are in a one-piece monolithic body. The tympanic membrane portion 35 is configured to be located in the opening 30 between the base portion 25 and the head 15 when the artificial tympanic membrane 45 is located relative to the auditory canal 57 in a generally anatomically correct manner. The tympanic membrane portion 35 may include a portion of the horizontal canal 65 such that the artificial tympanic membrane 45 is inwardly recessed within the tympanic membrane portion 35 (as depicted in FIGS. 6 and 7) or the artificial tympanic membrane 45 may form the face of the tympanic membrane portion 35 such that generally the entirety of the horizontal canal 65 is provided by the artificial ear 20.

Depending on the embodiment, the tympanic membrane portion 35 may be received in recesses defined in both the head opening 30 and the artificial ear 20 (as shown in FIG. 7), or the tympanic membrane portion 35 may be received in a single recess that is defined only in either the head opening 30 or the artificial ear 20, the tympanic membrane portion 35 simply abutting against a planar surface of the portion (i.e., head opening or artificial ear) that does not have a recess defined therein.

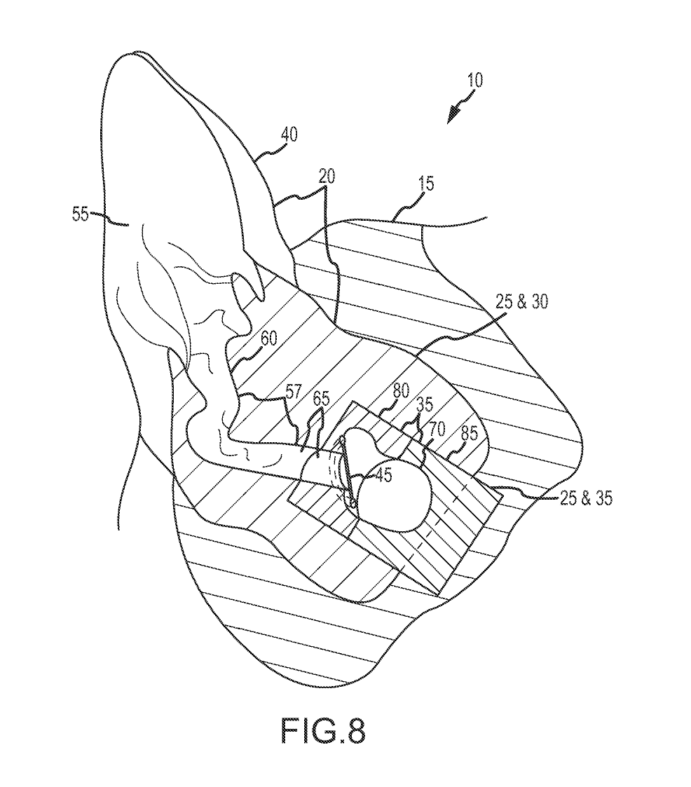

In one embodiment, as illustrated in FIG. 8, which is the same view as FIG. 5, and discussed with respect to the tympanic membrane portion 35 identified in FIG. 6 by arrow B, the tympanic membrane portion 35 includes an artificial tympanic membrane 45 and a tympanic bulla 70 immediately adjacent the artificial tympanic membrane 45. The artificial tympanic membrane 45 and tympanic bulla 70 are in a two-piece arrangement wherein the artificial tympanic membrane 45 is located in a first piece 80 and the tympanic bulla 70 is located in a second piece 85 sandwiched with the first piece 80 when held between the artificial ear 20 and head 15.

As with the embodiment discussed with respect to FIG. 7, the tympanic membrane portion 35 of the embodiment of FIG. 8 is configured to be located in the opening 30 between the base portion 25 and the head 15 when the artificial tympanic membrane 45 is located relative to the auditory canal 57 in a generally anatomically correct manner. The first piece 80 of the tympanic membrane portion 35 may include a portion of the horizontal canal 65 such that the artificial tympanic membrane 45 is inwardly recessed within the tympanic membrane portion 35 (as depicted in FIGS. 6 and 8) or the first piece 80 of the artificial tympanic membrane 45 may form the face of the tympanic membrane portion 35 such that generally the entirety of the horizontal canal 65 is provided by the artificial ear 20.

As shown in FIG. 8, the first piece 80 of the tympanic membrane portion 35 may include a portion of the tympanic bulla 70 and the second piece 85 may include the rest of the tympanic bulla 70. Alternatively, the second piece 85 may include substantially all of the tympanic bulla 70, with the first piece 80 having the artificial tympanic membrane 45 positioned immediately against the joining line of the two pieces such that the first piece 80 includes little or no part of the tympanic bulla 70.

Depending on the embodiment, the two-piece tympanic membrane portion 35 may be received in recesses defined in both the head opening 30 and the artificial ear 20 (as shown in FIG. 8), or the two-piece tympanic membrane portion 35 may be received in a single recess that is defined only in either the head opening 30 or the artificial ear 20, the tympanic membrane portion 35 simply abutting against a planar surface of the portion (i.e., head opening or artificial ear) that does not have a recess defined therein.

The artificial ear 20 and artificial tympanic membrane 45 and tympanic bulla 70 may be similar to their corresponding real structures in both appearance and physical characteristics. The artificial structures 20, 45, 70 may have accurate surface detail and realistic color and texture that closely mimics the surface of corresponding real structures. The shape of the artificial structures 20, 45, 70 may include the anatomical features common to the real corresponding structures, the anatomical features being correct with respect to shape, size and location.

In one embodiment, the artificial tympanic membrane 45 and/or tympanic bulla 70 are configured with respect to at least one of appearance or touch to mimic a specific real tympanic membrane medical condition. For example, the artificial tympanic membrane 45 and, in some embodiments, the adjacent regions of the tympanic membrane portion 35, have colors, tactile qualities (e.g., textures, resilience, etc.), shapes, etc. that mimic those of actual medical conditions of the tympanic membrane and adjacent regions. In one embodiment, the otoscopic model 10 may include multiple tympanic membrane portions 35 for use with a single artificial head 15 and one or more artificial ears 20. Each tympanic membrane portion 35 may represent a specific medical condition of an ear. If multiple artificial ears 20 are provided, each such ear 20 may also represent a specific medical condition by itself or in conjunction with a specific tympanic membrane portion 35.

Thus, in one embodiment, the otoscopic model 10 provides a diagnostic and treatment training experience that is very similar to a real diagnostic and treatment experience. Example diagnosis and treatment skills that can be practiced on such an otoscopic model 10 include myringotomies, otitis externa, deep ear canal cleaning, etc. The size and configuration of otoscopic model 10 may be tailored to represent the head and ear structure of a human or specific animal. Also, the artificial tympanic membrane 45 may be configured to have a normal, healthy shape or an abnormal or enlarged shape with punctures, discolorations, growths, abnormalities, injuries, etc. that can be diagnosed and the subject of a treatment technique. Different consistencies and textures for the material forming the artificial ear and its structures can be used so as to approximate a healthy, normal ear or an ear having a specific type of disease.

An instructor may desire to test a student with respect to diagnosing and/or treating a variety of ear medical conditions. The instructor selects a tympanic membrane portion 35 corresponding to a known ear medical condition and inserts the portion 35 and artificial ear 20 into the head opening 30. The student then conducts and ear examination using an otoscope and/or video otoscope on the otoscopic model 10 and the instructor can assess the student with respect to examination technique due to the model's realism and assess whether or not the student is capable of correctly identifying the medical condition of the ear. If a treatment is warranted, the student can then perform a realistic treatment on the artificial ear due to the realism of the ear. Once the student has correctly assessed the medical condition and/or treated the medical condition, the tympanic membrane portion 35 the student has been assessing/treating can be changed out by the instructor to another tympanic membrane portion 35 exhibiting traits common to another ear medical condition and the assessment process can begin anew for the student.

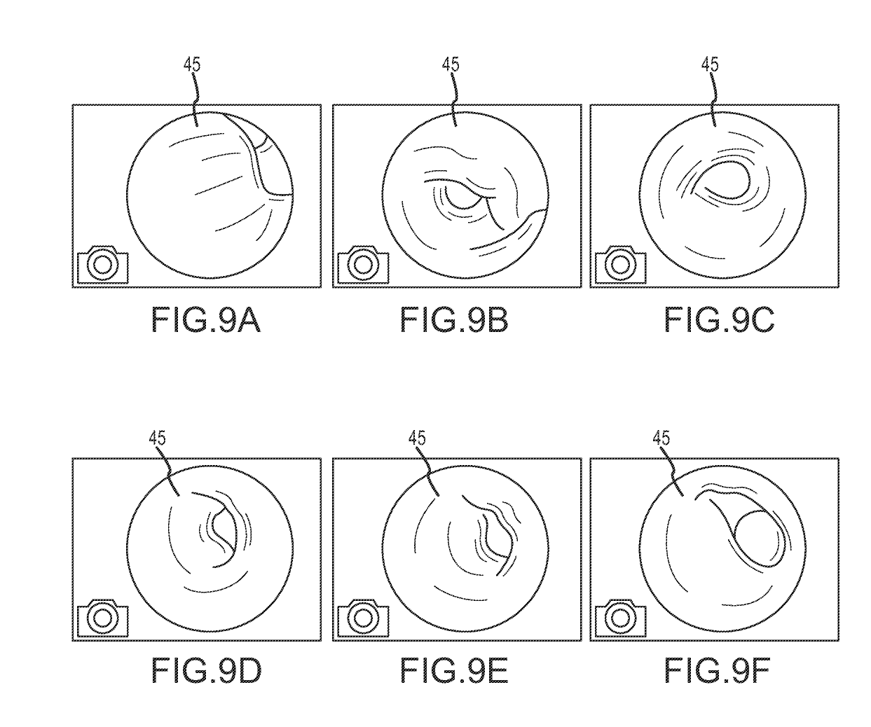

An understanding of how the artificial tympanic membranes 45 of different tympanic membrane portions 35 may differ in appearance although used with the same artificial ear 20 and head 15 can be obtained from FIG. 9A-9F, which are six otoscopic photographs of different artificial tympanic membranes 45 of different tympanic membrane portions 35 that are intended to reflect six different ear medical conditions. Thus, the various tympanic membrane portions 35 can be substituted within the rest of the model 10 for simulation of different tympanic membrane pathologies.

As indicated in FIG. 1, in one embodiment, the model 10 includes a base 100 that supports the head 15 of the model 10 in an adjustable manner. For example, a ball 105 may be supported via a pedestal 110 off of a base plate 115 of the base 100. The ball 105 may be received in a socket 120 defined in the neck or bottom region of the head 15 of the model 10. The ball and socket arrangement allows for a wide range of motion and for appropriate positioning of the head and its ear. Thus, depending on the instructional scenario, the model can be tilted on the base 100 so as to increase or decrease the difficulty for the trainee or to teach the trainee the best head positioning for the performance of different tasks.

In one embodiment, the ear portion 40 of the artificial ear 20 is substantially formed of platinum cured room temperature vulcanization silicone rubber (“PCRTVS”). The ear portion 40 of the artificial ear 20 may be formed of one type of PCRTVS, and the artificial tympanic membrane 45 may be formed of another type of PCRTVS. In one embodiment, the artificial head 10 is substantially formed of polyurethane.

A discussion regarding a method of manufacturing the model 10 is now provided. In one embodiment, molds of the head and ear are provided. In one embodiment, the molds are sculpted or machined to resemble negative of a head and ear the model 10 is to replicate. In another embodiment, the molds are a result of initial molds taken of a head and ear of a living or deceased creature or a sculpted liver body. For example, short-lived molds are created from an original that may be deceased, alive, or sculpted. Clay positives are cast utilizing the short-lived molds, the clay positives representing the head and ear. The clay positives are corrected as needed, in accordance to the objective of the final product. As an example, it may be desirable to have more anatomically correct molds if the objective is the training of surgical approaches or techniques that require recognition of specific landmarks.

Polyurethane molds are then formed about the clay positives. In doing so, borders are created around the clay positives with a moldable oil based soft clay. The molds are then pulverized with a release agent and allowed to dry. A first layer of polyurethane Shore A 30 is then poured or painted over the clay positives, followed by a minimum of three and a maximum of five layers of the same material, which are reinforced with polyester fibers. A period of 15-20 minutes is allowed to elapse between layers of polyurethane. Once all layers of polyurethane are laid up, the polyurethane molds are left to completely cure for a period of 24 hours prior to being used in the molding of the artificial head 15 and ear 20 of the model 10. Some of the mold embodiments require a hard shell in order to prevent permanent deformation or simply to facilitate handling of the mold. In one embodiment, the outer shell is created using a fast set liquid plastic. In other embodiments, the outer shell is created using other materials, such as, for example, plaster and fiberglass. Some molds will be multi-part and, as a result, will have an outer shell so as to facilitate the creation of a tight seal between the edges of the mold.

Each mold has a first portion and a second portion, each of said portions having a void defined therein that corresponds to a negative of a surface of one side of the item to be molded via the mold (e.g., the head or ear). The mold portions mate together such that the voids in each portion form a complete void that has a shape and volume corresponding to the real head or ear to be modeled.

Once the molds are provided, the manufacture of the artificial head and ear can begin. For example, the material used to form the artificial head is poured, sprayed, injected or otherwise deposited into the void of the head mold. In one embodiment, the material deposited in the artificial head mold is polyurethane, such as, for example, Reoflex 30 from Smooth-on® 2000 Saint John Street, Easton Pa. 18042.

Similarly, the material used to form the artificial ear is poured, sprayed, injected or otherwise deposited into the void of the corresponding mold. In one embodiment, the material deposited in the artificial ear mold is PCRTVS. In one embodiment, the PCRTVS for the artificial ear is PCRTVS durometer Shore A10 or PCRTVS durometer Shore OO50. Thus, in one embodiment, the artificial ear 20 of the model 10 has a cured durometer of approximately Shore A10 or approximately Shore OO50.

In one embodiment, the PCRTVS durometer Shore OO50 is Ecoflex OO50®, and the PCRTVS durometer Shore A10 is Dragon Skin 10®, all of which are manufactured by Smooth-on of Easton, Pa. As can be understood by those skilled in the art, the Shore durometer numbers provided above represent the Shore durometer of the respective cured material.

The base 25 of the ear 20 and the hole 30 of the head 15 are configured (e.g., via the molding process) so as to result in a complementary interference fit between the base 25 and hole 30 when the base is received in the hole. For example, as can be understood from FIGS. 4 and 6, the base 25 may have conical shape that helps to maintain the base 25 securely within the hole 30.

In one embodiment, the mold for the artificial tympanic portion 35 is sculpted or machined so as to have one of the configurations discussed above with respect to FIGS. 4 and 6. The ear 20 and the portion 35 may be configured such that the portion 35 is appropriately received in the ear 20, as discussed with respect to FIGS. 4-8 above. For example, the portion 35 could be in the form of a disk and a slot 75 could be defined in the ear 20, as discussed above with respect to FIGS. 4 and 5. Alternatively, the ear base 25 and/or inner face of the hole 30 could be configured to receive the portion 35 which is in the form of a cylinder, as discussed above with respect to FIGS. 6-8.

The material used to form the artificial tympanic portion 35 and, more specifically, its artificial tympanic membrane 45 is poured, sprayed, injected or otherwise deposited into the void of the corresponding mold. In one embodiment, the material deposited in the artificial tympanic portion mold is PCRTVS. In one embodiment, the PCRTVS for the artificial tympanic portion is PCRTVS durometer Shore A10 or PCRTVS durometer Shore OO10. Thus, in one embodiment, the artificial tympanic portion 35 of the model 10 has a cured durometer of approximately Shore A10 or approximately Shore OO50.

In one embodiment, the PCRTVS durometer Shore A10 is Dragon Skin A10®, and the PCRTVS durometer Shore OO50 is Ecoflex OO50®, all of which are manufactured by Smooth-on of Easton, Pa. As can be understood by those skilled in the art, the Shore durometer numbers provided above represent the Shore durometer of the respective cured material.

In one embodiment, the artificial tympanic membrane 45 will have a relatively thin transverse cross sectional thickness, much like a real tympanic membrane found in the ear of a human or animal. For example, in one embodiment, the artificial tympanic membrane 45, which is made from PCRTVS, has a transverse cross sectional thickness of between approximately 0.25 mm and approximately 0.5 mm.

In one embodiment, the ear canal 57 and/or tympanic bulla 70 are formed of a first type of PCRTVS, and the rest of the artificial ear 20 and/or artificial tympanic portion 35 in which said structures are defined are formed of another type of PCRTVS. For example, in one embodiment, the ear canal 57 and/or tympanic bulla 70 are formed of PCRTVS durometer Shore OO50, and the artificial ear 20 and or artificial tympanic portion 35 are formed of PCRTVS durometer Shore A 10. In one embodiment, the ear canal 57 and/or tympanic bulla 70 are first molded and allowed to cure. These cured portions 57 and/or 70 are then supported in the cavity of the mold used to form the rest of the artificial ear 20 and/or artificial tympanic portion 35, and the ear 20 and portion 35 are then molded about the molded and cured canal 57 and bulla 70.

For each of the above-described molded portions, specifically, the head 15, ear 20 and tympanic portion 35, the materials from which the molded portions are created can be provided with mixed-in color or tint, mixed in fibers or textures, and surface color, tint or texture to mimic as closely as possible the touch and appearance of the artificial head 15, artificial ear 20 and artificial tympanic membrane 45 and other ear structures.

For each of the above-described molded portions, specifically, the head 15, ear 20 and tympanic portion 35, once the material used to form these components of the model 10 has cured within their respective molds, each mold is opened by separating its two portions from each other. The molded components of the model are then removed from its respective mold and the components can be combined together to form the model.

The model 10 disclosed herein is a life like representation of the head 20 and ear structure 25 of a real living animal (e.g., a dog). The disclosure provided herein is applicable to all animals and humans having an ear structure. The ear structure includes a realistic auditory canal with a tympanic membrane and bulla. The ear structures are built with different types of PCRTV having distinct textures, consistencies and colors resembling with close approximation the same textures, consistencies and colors encountered in organic specimens. The model is designed to create a situation or scenario that will allow a trainee to experience a close to real life auditory canal evaluation and to take appropriate action in order to remedy the pathology encountered. The ear, pina, auditory canal and head can be made in several different sizes, different shapes, colors and textures to mimic the anatomical geography and physical characteristics of the ones found in other animal species.

The model can be used for training purposes in evaluating a trainee's ear diagnosis and treatment skills. For example, the model can be used to evaluate and train the trainee's ear handling abilities, conventional and video otoscopic evaluation of vertical and horizontal canals including the tympanum, gross examination and recognition of anatomic landmarks, especially at the entrance to the vertical canal, identification of pathologies associated with the ear canal, tympanic membrane and tympanic bulla, removal of foreign bodies, collection of samples for culture and cytology, etc. The model can also be used for training of middle ear cleaning, deep ear canal cleaning with the utilization of alligator forceps, ear curettes, or ear brushes, flushing and suctioning under use of conventional surgical otoscopes and video otoscopes.

Although the present invention has been described with reference to preferred embodiments, persons skilled in the art will recognize that changes may be made in form and detail without departing from the spirit and scope of the invention.

What is claimed is:

1. An otoscopic model comprising:
an artificial ear comprising a base portion and an ear portion extending from the base and having ear-like features including an auditory canal;
an artificial head comprising an opening adapted to receive the base portion; and
at least one tympanic membrane portion comprising an artificial tympanic membrane, the tympanic membrane portion configured to be coupled with the artificial ear such that the artificial tympanic membrane is located relative to the auditory canal in a generally anatomically correct manner.

2. The model of claim 1, wherein the at least one tympanic membrane portion comprises the artificial tympanic membrane, and a ring that supports the artificial tympanic membrane and across which the artificial tympanic membrane extends.

3. The model of claim 2, wherein the ear-like features of the artificial ear further includes a tympanic bulla, and the artificial ear further comprises an access extending into the artificial ear that is configured to receive the at least one tympanic membrane portion between the auditory canal and the tympanic bulla when the artificial tympanic membrane is located relative to the auditory canal in a generally anatomically correct manner.

4. The model of claim 3, wherein the access includes a slot.

5. The model of claim 1, wherein the at least one tympanic membrane portion comprises the artificial tympanic membrane and a tympanic bulla immediately adjacent the artificial tympanic membrane.

6. The model of claim 5, wherein the artificial tympanic membrane and tympanic bulla are in a one-piece monolithic body.

7. The model of claim 5, wherein the artificial tympanic membrane and tympanic bulla are separate bodies.

8. The model of claim 5, wherein the at least one tympanic membrane portion is configured to be located in the opening between the base portion and the head when the artificial tympanic membrane is located relative to the auditory canal in a generally anatomically correct manner.

9. The model of claim 8, wherein the base portion includes a recess in which at least a portion of the at least one tympanic membrane portion is received when the at least one tympanic membrane portion is located in the opening between the base portion and the head.

10. The model of claim 1, wherein the artificial tympanic membrane is configured with respect to at least one of appearance or touch to mimic a specific real tympanic membrane medical condition.

11. The model of claim 1, wherein the at least one tympanic membrane portion includes is multiple tympanic membrane portions each comprising an artificial tympanic membrane mimicking with respect to at least on of appearance or touch a different tympanic membrane medical condition.

12. The model of claim 1, wherein the ear portion of the artificial ear is substantially formed of platinum cured room temperature vulcanization silicone rubber (“PCRTVS”).

13. The model of claim 1, wherein the ear portion of the artificial ear is formed one type of PCRTVS and the artificial tympanic membrane is formed of another type of PCRTVS.

14. The model of claim 13, wherein the ear portion of the artificial ear is substantially formed of PCRTVS durometer Shore A10, and the artificial tympanic membrane is substantially formed of PCRTVS durometer Shore OO10.

15. The model of claim 1, wherein the head is formed of polyurethane.

16. The model of claim 1, further comprising a base coupled to the artificial head and configured to support the artificial head off of a surface.

17. The model of claim 16, where the base is coupled to the artificial head via a ball and socket arrangement.
